(19) United States
(12) Patent Application Publication
(10) Pub. No.: US 2026/0315839 A1
(43) Pub. Date: Oct. 15, 2026

(54) BLOCKING DEVICE FOR A WIRE ELEMENT

(71) Applicant: ZEDEL, Crolles (FR)

(72) Inventors: Alain MAURICE, Le Plateau des Petites Roches (FR); Michael CHAUMONTET, Crolles (FR)

(73) Assignee: ZEDEL, Crolles (FR)

(21) Appl. No.: 19/644,420

(22) Filed: Apr. 10, 2026

(30) Foreign Application Priority Data
Apr. 10, 2025 (FR) 2503867

(51) Int. Cl. A62B 35/00

(52) U.S. Cl. CPC A62B 35/0081; A62B 35/0037

(57) ABSTRACT

A blocking device comprises a body defining a groove, a plate movably mounted between a working position and an installation position with a rotating roller. A control device has a first catch and a second catch. When at least one of the first catch and the second catch is in a blocking position, the control device is in a locked position. The plate being in the working position, the first catch and the second catch in the blocking position are arranged protruding from or flush with the first wall. The first catch and the second catch are arranged in the blocking position, the second catch is more protruding than the first catch relative to the first wall.

### TECHNICAL FIELD

The invention relates to a blocking device for a wire element.

### STATE OF THE ART

During work at height, to ensure the safety of the person intervening, it is necessary to connect them to a rope acting as a lifeline. The person is attached to a fall arrest device that travels along the lifeline. The fall arrest device has a rotating roller configured to rotate in one direction or another depending on whether the person is ascending or descending.

During a fall, the vertical speed of the fall arrest device along the lifeline reaches a threshold value, which corresponds to a threshold rotation speed of a roller relative to a plate of the fall arrest device. When the threshold rotation speed is reached, the roller locks, which has the effect of blocking the fall arrest device on the lifeline. The person attached to the fall arrest device is then stopped in their fall.

To form an effective and pleasant-to-use fall arrest device, it is important that the fall arrest device can faithfully follow the rope technician's progression, meaning that the fall arrest device moves with low friction in one direction or the other. It is also important that the fall arrest device effectively detects the travel speed of the fall arrest device along the lifeline, which corresponds to significant contact between the roller and the lifeline and thus to non-negligible friction. A fall arrest device configuration is marketed by PETZL company under the name "ASAP".

Different fall arrest device configurations are disclosed in documents US 2014/0196985 and US 2014/0262611. Document US 2014/0196989 discloses a fall arrest device provided with a rotating roller which is movable relative to a body in order to define a working position and an installation position. In the working position, the roller presses the rope against the bottom of the groove to have good contact with the rope and better detect relative movements between the fall arrest device and the rope. In the installation position, the roller opens the groove so that the rope can be installed or removed.

When the rope has a large diameter, the roller approaches the installation position. The catches used to maintain the roller in the working position are pushed less deeply into the body. To ensure the catches are always accessible and movable within the volume defined by the body, a bulky body and/or small-sized catches are used.

The aim is to form a fall arrest device that is less bulky than prior art configurations. It is observed that the smaller the body, the more the dimensions of the catches tend to be reduced, which can make their use more complicated, especially when the user is wearing gloves. Finally, the miniaturization of the fall arrest device must not modify its behavior, and more particularly its ability to block a fall.

### DISCLOSURE OF THE INVENTION

An object of the invention consists in providing a blocking device which is less sensitive to unintentional opening of the fall arrest device while allowing easier opening.

This problem tends to be solved by means of a blocking device for blocking a wire element comprising:
a body defining a groove intended to receive the wire element and a first wall, the first wall facing a bottom of the groove in an observation along a first direction, the first direction being perpendicular to a direction of movement of the wire element along the groove;
a roller rotatably mounted around a first rotation shaft, the first rotation shaft defining a first axis of rotation for the roller, the first direction passing through the axis of rotation of the roller;
a plate fixed to the body and movably mounted relative to the body between a working position and an installation position, the first rotation shaft being fixed to the plate to move with the plate, in the working position, the roller being intended to press the wire element against a bottom of the groove, in the installation position, the roller releasing access to the groove to install or remove the wire element;
a control device having a locked position and an unlocked position, in the locked position the control device prohibits movement of the plate from the working position to the installation position, in the unlocked position the control device allows movement of the plate from the working position to the installation position; wherein the control device has a first catch and a second catch each mounted freely movable between a blocking position and an unblocking position, when at least one of the first catch and the second catch is in the blocking position, the control device is in the locked position and when the first catch and the second catch are in the unblocking position, the control device is in the unlocked position.

The blocking device is remarkable in that, the plate being in the working position, the first catch and the second catch in the blocking position are arranged protruding from or flush with the first wall; and in that the first catch and the second catch being arranged in the blocking position, the second catch is more protruding than the first catch relative to the first wall.

Preferably, the first catch is movably mounted in a first plane between the blocking position and the unblocking position. The second catch has a cover extending above the first catch along the first plane.

Advantageously, when the first catch and the second catch are in the blocking position, the cover is arranged closer to the first wall than a top wall of the first catch.

In an advantageous development, the first catch and the second catch are pivotally mounted around a same pivot shaft attached to the plate.

### BRIEF DESCRIPTION OF THE DRAWINGS

Further advantages and features will become clearer from the following description of specific embodiments and methods of implementing the invention, which are provided as non-limiting examples and illustrated in the accompanying drawings, in which:

FIG. 1: schematically illustrates a front view of a fall arrest device, the two catches being in the blocking position;

FIG. 2: schematically illustrates a front view of a fall arrest device, the first catch being in the blocking position and the second catch being in the unblocking position;

FIG. 3: schematically illustrates a side view of a fall arrest device, the two catches being in the blocking position;

FIG. 4: schematically illustrates a side view of a fall arrest device, the first catch being in the blocking position and the second catch being in the unblocking position;

FIG. 5: schematically illustrates a perspective view of a fall arrest device, the two catches being in the blocking position;

FIG. 6: schematically illustrates a perspective view of a fall arrest device, the first catch being in the blocking position and the second catch being in the unblocking position;

FIG. 7: schematically illustrates another perspective view of a fall arrest device, the two catches being in the blocking position;

FIG. 8: schematically illustrates another perspective view of a fall arrest device, the first catch being in the blocking position and the second catch being in the unblocking position.

### DESCRIPTION OF THE EMBODIMENTS

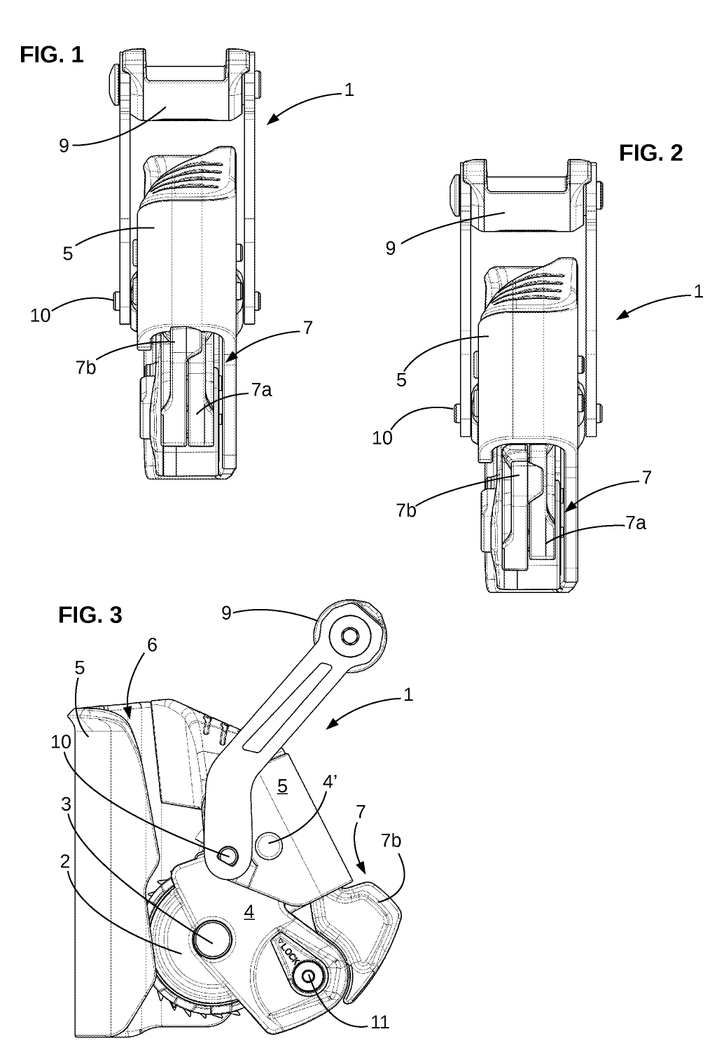

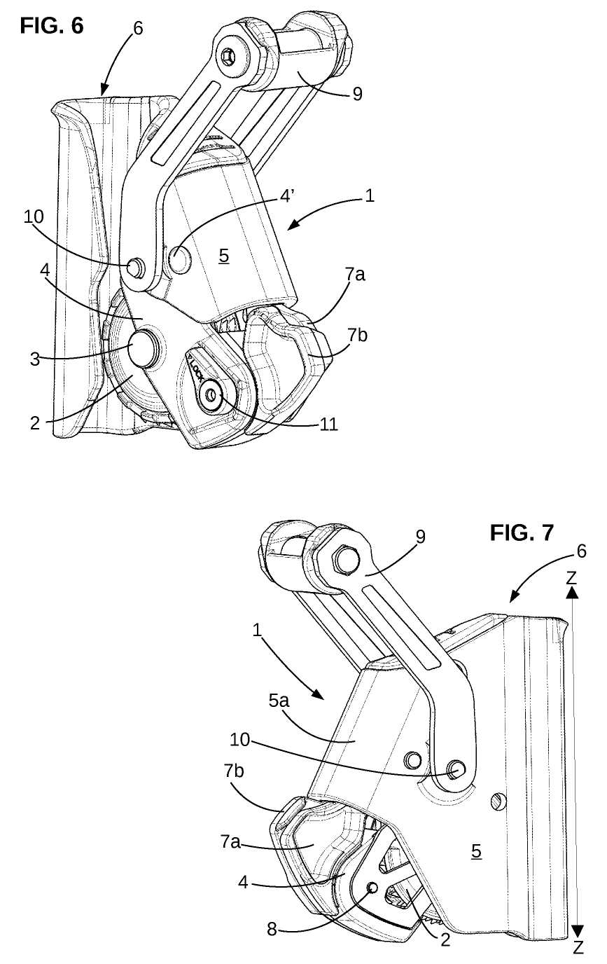

FIGS. 1 to 8 illustrate different views of a blocking device 1 configured to block a wire element 12, preferably a rope. The blocking device 1 is preferably a fall arrest device. The blocking device 1 comprises a roller 2 rotatably mounted in at least a first direction of rotation around a first rotation shaft 3. The first rotation shaft 3 defines a first axis of rotation for the roller 2. The blocking device 1 defines a path intended for the passage of the wire element 12. The path defines a through-passage of which one wall is formed by the roller 2 so that the sliding of the wire element 12 in the blocking device 1 causes the rotation of the roller 2.

The blocking device 1 is preferably configured to block the rotation of the roller 2 in at least a first direction of rotation, preferably when the rotation speed of the roller 2 around the first axis of rotation reaches a threshold value. Preferably, the roller 2 is configured to rotate freely in both directions of rotation at least when the rotation speed is lower than the threshold value.

The blocking device 1 comprises a detection device configured to detect the rotation speed of the roller 2 in the first direction of rotation. The detection device is configured to allow the rotation of the roller 2 when the rotation speed in the first direction of rotation is lower than the threshold speed and to prevent the rotation of the roller 2 when the rotation speed of the roller 2 in the first direction of rotation reaches the threshold speed. When the detection device detects that the rotation speed in the first direction of rotation corresponds to the threshold speed, the roller 2 locks, which has the effect of blocking the wire element 12 possibly present in the blocking device 1. Preferably, the blocking device 1 allows the rotation of the roller 2 in the second direction of rotation regardless of the rotation speed.

The roller 2 is fixed to the first rotation shaft 3. The first rotation shaft 3 passes through the roller 2 or is embedded in the roller 2 so that the roller 2 turns around the first rotation shaft 3. The first rotation shaft 3 is fixed to a plate 4 and preferably moves in a similar manner to the plate 4.

The plate 4 is fixed to a body 5 which defines a groove 6. The groove 6 is intended to receive the wire element 12. The groove 6 extends along a longitudinal direction ZZ which corresponds to a longitudinal direction of the wire element 12 arranged inside the groove 6. The longitudinal direction ZZ also corresponds to the direction of movement of the wire element 12 relative to the body 5 when the wire element 12 is arranged between the bottom of the groove 6 and the roller 2.

The plate 4 is movably mounted relative to the body 5 between a working position and an installation position. In the working position, the roller 2 presses on the wire element 12 to place the wire element 12 against the bottom of the groove 6. The wire element 12 is arranged between the bottom of the groove 6 and the roller 2. When the blocking device 1 moves along the wire element 12, i.e., along the longitudinal direction ZZ, the roller 2 is able to rotate to follow the movement along the wire element 12. It is advantageous for the blocking device 1 to have a spring having one end connected to the body 5 and another end connected to the plate 4, the state of lowest deformation or the state of rest of which corresponds to the roller 2 arranged in the immediate vicinity of the bottom of the groove 6. In the working position, the wire element 12 prevents the roller 2 from reaching its rest position and therefore applies a stress on the spring, which allows for good contact between the roller 2 and the wire element 12 resting against the bottom of the groove 6.

In the installation position, the roller 2 moves away from the bottom of the groove 6 and moves sufficiently far from the bottom of the groove 6 to delimit a slot with the body 5. The slot allows for introduction or removal of the wire element 12. The introduction and removal of the wire element 12 are carried out with a component parallel to the axis of rotation of the roller 2.

To avoid an undesired movement of the plate 4 from the working position to the installation position, which results in a loss of sensitivity in movements along the wire element 12, the blocking device 1 has a control device 7 which has a locked position and an unlocked position.

In the locked position, the control device 7 maintains the plate 4 in the working position. In other words, the plate 4 is unable to leave the working position to reach the installation position. In the unlocked position, the control device 7 allows movement of the plate 4 from the working position to the installation position.

Advantageously, when the plate 4 is in the installation position, it is possible for the plate 4 to reach the working position regardless of the position taken by the control device 7. The control device 7 is not able to prevent a movement of the plate 4 to the working position, including when the control device 7 is in a locked position. In an alternative embodiment, the control device 7 in the locked position prevents movement of the plate 4 from the installation position to the working position.

The control device 7 has a first catch 7a and a second catch 7b. Each of the first catch 7a and the second catch 7b has a blocking position and an unblocking position. FIGS. 1, 3, 5, and 7 illustrate the first catch 7a and the second catch 7b in the blocking position. FIGS. 2, 4, 6, and 8 illustrate the first catch 7a in the blocking position and the second catch 7b in the unblocking position.

When at least one of the first catch 7a and the second catch 7b is in the blocking position, the plate 4 is unable to move from the working position to the installation position. It is particularly advantageous that each catch can move independently of the other catch so that it is more difficult to have the control device 7 in the unlocked position.

To obtain the control device 7 in the unlocked position, it is necessary to act simultaneously on the first catch 7a and on the second catch 7b. It is advantageous that the first catch 7a and the second catch 7b are associated with a spring whose rest position or lowest stress position is the blocking position.

In a preferred embodiment, each of the first catch 7a and the second catch 7b in the blocking position forms an obstacle opposing the movement of the plate 4 out of the working position. Each of the first catch 7a and the second catch 7b bears on one hand against the body 5 and on the other hand against the plate 4 to prevent the movement of the plate 4 out of the working position.

In order to limit the bulk of the body 5 without degrading the use of the control device 7, it is advantageous that the first catch 7a and the second catch 7b each have a portion which is arranged protruding from the body 5 or flush with the body 5 when the first catch 7a and the second catch 7b are each in the blocking position and the plate 4 is in the working position. Preferably, the body 5 defines a first wall 5a which faces the groove 6 in an observation along a first direction. The first direction is a direction perpendicular to the longitudinal axis ZZ of the groove 6 which corresponds to the longitudinal axis of the wire element 12 installed in the groove 6 and which corresponds to the direction of movement of the wire element 12 relative to the body 5. The first direction passes through the axis of rotation of the roller 2.

The protruding or flush arrangement is observed along a direction parallel to the axis of rotation of the roller 2. The protruding or flush arrangement is observed relative to the extension of the first wall 5a.

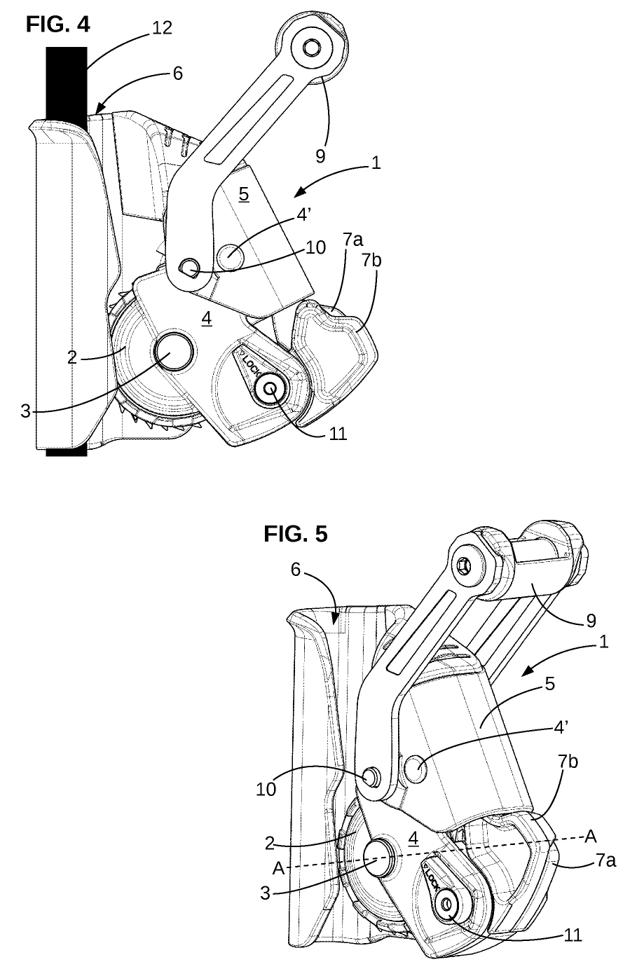

The wire element 12 is arranged between the groove 6 and the first wall 5a. The first wall 5a extends from an upper end to a lower end. The upper end and the lower end are opposite ends along the longitudinal direction ZZ. When the plate 4 is in the working position and the first catch 7a and the second catch 7b are in the blocking position, the first catch 7a and the second catch 7b protrude from or are flush with the plane defined by the first wall 5a from the upper end to the lower end. The protruding or flush arrangement is visible in FIGS. 3 and 4 which represent observations along the axis of rotation of the roller 2. The catches are in the extension of the lower end.

The protruding or flush installation of the catches in the extension of the first wall 5a makes it possible to easily find the catches without having to look at the blocking device 1. The catches being arranged protruding or flush and in the extension of the first wall 5a, they are more easily accessible because it is no longer necessary to place a finger inside the body 5 to grab the catches and move them from the blocking position to the unblocking position. The opening of the blocking device 1 is facilitated.

In the blocking position, the first catch 7a and the second catch 7b being protruding or flush with the body 5, it is advantageous that the control device 7 reduces the risks of unintentional actuation of at least one of the first catch 7a and the second catch 7b to maintain the plate 4 in the working position.

Advantageously, the control device 7 is configured so that when the first catch 7a is in the blocking position, the movement of the second catch 7b has no effect on the first catch 7a and vice-versa. Preferably, when the second catch 7b is in the unblocking position, the movement of the first catch 7a has no effect on the second catch 7b and vice-versa. Although both catches are more easily accessible than in the configuration according to the prior art, moving the plate 4 from the working position to the installation position is only possible after simultaneously stressing the first catch 7a and the second catch 7b.

It is advantageous that the second catch 7b in the blocking position is more protruding from the first wall 5a than the first catch 7a in the blocking position. The second catch 7b extends higher above the first wall 5a. In the event of an object sliding along the first wall 5a, the object is more likely to catch the second catch 7b than the first catch 7a so that the risk of unintentional movement of the first catch 7a is lower. By "more protruding", it is meant that the first catch 7a can be flush and the second catch 7b is protruding or that the first catch 7a and the second catch 7b are both protruding.

The first catch 7a being less protruding than the second catch 7b, an element sliding along the first wall 5a and coming into contact with the second catch 7b is less likely to catch the first catch 7a.

It is even more advantageous that the second catch 7b forms a cover above the first catch 7a. The second catch 7b extends facing the first catch 7a in a plane containing the movement of the first catch 7a between the blocking position and the unblocking position, i.e., a plane which contains the multiple positions accessible to the first catch 7a between the blocking position and the unblocking position. With the second catch 7b extending facing the first catch 7a and above the first catch 7a, the probability of an object sliding along the first wall 5a catching the first catch 7a is very low. The probability of catching the second catch 7b increases, but as the plate 4 cannot leave the working position as long as the first catch 7a is in the blocking position, the probability of unintentional movement of the plate 4 is very low.

Preferably, in the blocking position, the wall forming the top of the first catch 7a is further from the first wall 5a than the wall forming the top of the second catch 7b. The distance is observed along the direction of extension of the first wall 5a from the upper end to the lower end.

The top of a catch is the part of the catch intended to be touched when an object slides along the first wall 5a to the catch. For example, when the catch is pivotally mounted, the top of the catch may be the wall furthest from the pivot axis.

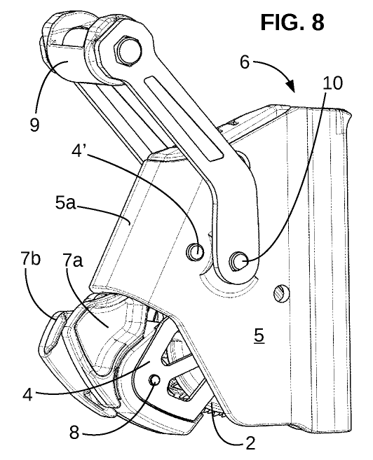

By placing the top of the first catch 7a further from the first wall 5a than the top of the second catch 7b, the probability of an object sliding along the first wall 5a coming into contact with the second catch 7b without acting on the first catch 7a is increased. The pivoting of the second catch 7b can induce a modification of the trajectory of the object sliding along the first wall 5a and reduce the probability of catching the first catch 7a. It is particularly advantageous that the cover, if applicable, is arranged closer to the first wall 5a than the top of the first catch 7a. As illustrated in FIG. 7, the second catch 7b has a top which is protruding from the first wall 5a and which is in contact with the body 5. The first catch 7a has a different shape defining a gap between the top and the body 5 in the extension of the first wall 5a.

Preferably, the top of the first catch 7a is in the form of an arc of a circle whose center is the axis of rotation of the first catch 7a. It is also advantageous that the lower wall of the top of the second catch 7b is an arc of a circle whose center is the axis of rotation of the first catch 7a and the second catch 7b. This configuration makes it possible to define an air gap between the first catch 7a and the second catch 7b which is in the form of an arc of a circle in order to facilitate independent movement between the first catch 7a and the second catch 7b.

Advantageously, the first catch 7a and the second catch 7b each define a cavity 7' in a side wall, which facilitates the pressing of a finger to perform the movement of the catches. Each cavity 7' is made along a direction perpendicular to the plane representative of the movement of the associated catch between the blocking position and the unblocking position. When the first catch 7a and the second catch 7b are arranged adjacent, the two cavities 7' are made on the opposite external side walls. This allows, for example, gripping with the thumb and index finger to move the two catches simultaneously.

In a preferred embodiment, the plate 4 is pivotally mounted relative to the body 5 between the working position and the installation position. The plate 4 is pivotally mounted around a plate shaft 4' which fixes the plate 4 to the body 5. It is particularly advantageous that the pivot axis of the plate 4 is parallel to the axis of rotation of the roller 2. The working position of the plate 4 is defined by the diameter of the wire element 12 installed in the groove 6. The larger the diameter, the more the first catch 7a and the second catch 7b can be protruding relative to the first wall 5a. For example, the larger the diameter of the wire element 12, the further the roller 2 moves from the bottom of the groove 6 to approach the first wall 5a.

Advantageously, at least one of the first catch 7a and the second catch 7b is pivotally mounted relative to the plate 4. Preferably, the first catch 7a and the second catch 7b are pivotally mounted around the same catch shaft 8. Preferably, the catch shaft 8 is attached to the plate 4 and moves identically to the plate 4.

It is advantageous that the first catch 7a and the second catch 7b are pivotally mounted around a pivot axis which is parallel to the pivot axis of the plate 4. Preferably, the pivot axis of the plate 4 is different from the pivot axis of the catches. Advantageously, the first catch 7a and the second catch 7b are installed adjacent along the pivot axis of the two catches. In this case, the plane representative of a movement of the catch is a plane perpendicular to the pivot axis.

In a particular embodiment, the catch shaft 8 is fixedly mounted relative to the first rotation shaft 3.

The blocking device (1) is provided with an attachment device 9 intended to be fixed to the user in order to follow their progression along the wire element 12. The attachment device 9 can be fixed directly to the user or it can be connected to the user by means of a lanyard or an energy absorber. The attachment device 9 is preferably in the form of a U which is pivotally mounted around an attachment shaft 10.

In the particular embodiment illustrated in FIGS. 1 to 8, the body 5 is formed by a metal sheet deformed into a "C" shape. The roller 2 and the plate 4 are arranged at least partly inside the "C".

The blocking device 1 can be provided with a lock 11 which has a first position allowing rotation of the roller 2 in both directions of rotation and a second position allowing rotation in only one direction, which corresponds to movement of the blocking device 1 only in the ascending direction.

1. Blocking device for blocking a wire element comprising:
a body defining a groove intended to receive the wire element and a first wall, the first wall being opposite a bottom of the groove in an observation along a first direction, the first direction being perpendicular to a direction of movement of the wire element along the groove;
a roller rotatably mounted around a first rotation shaft, the first rotation shaft defining a first axis of rotation for the roller, the first direction passing through the axis of rotation of the roller;
a plate fixed to the body and movably mounted relative to the body between a working position and an installation position, the first rotation shaft being fixed to the plate to move with the plate, in the working position, the roller being intended to press the wire element against a bottom of the groove, in the installation position, the roller releasing access to the groove to install or remove the wire element;
a control device having a locked position and an unlocked position, in the locked position the control device prohibits movement of the plate from the working position to the installation position, in the unlocked position the control device allows movement of the plate from the working position to the installation position;
wherein the control device has a first catch and a second catch each mounted freely movable between a blocking position and an unblocking position, when at least one of the first catch and the second catch is in the blocking position, the control device is in the locked position and when the first catch and the second catch are in the unblocking position, the control device is in the unlocked position;
wherein, the plate being in the working position, the first catch and the second catch in the blocking position are arranged protruding from or flush with the first wall; and
wherein the first catch and the second catch being arranged in the blocking position, the second catch is more protruding than the first catch relative to the first wall.

2. Blocking device for a wire element according to claim 2, wherein, when the first catch and the second catch are in the blocking position, the cover is arranged closer to the first wall than a top wall of the first catch.

3. Roping harness according to claim 1, wherein the dorsal portion of the first shoulder strap is attached to the dorsal portion of the second shoulder strap by a shoulder strap wire element, and wherein the connector is fixedly attached to the shoulder strap wire element.

4. Roping harness according to claim 2, wherein the dorsal portion of the first shoulder strap is attached to the dorsal portion of the second shoulder strap by a shoulder strap wire element, and wherein the connector is fixedly attached to the shoulder strap wire element.

5. Blocking device for a wire element according to claim 2, wherein the first catch and the second catch are pivotally mounted around a same pivot shaft attached to the plate.

6. Blocking device for a wire element according to claim 3, wherein the first catch and the second catch are pivotally mounted around a same pivot shaft attached to the plate.
